(19) United States
(12) Patent Application Publication
(10) Pub. No.: US 2015/0032605 A1
(43) Pub. Date: Jan. 29, 2015

(54) SYSTEMS AND METHODS FOR DIGITAL CHECK CONVERSION

(71) Applicant: First Data Corporation, Greenwood Village, CO (US)

(72) Inventors: Charles Rey Williams, Houston, TX (US); Michael Ehiosu Eke, Richmond, TX (US); Curtis Joseph Kantor, Houston, TX (US); Mollie Hellige, Houston, TX (US); Betty Wilson, Greenwood Village, CO (US); Susan Roy, Greenwood Village, CO (US); Corey Chao, Sugar Land, TX (US); Maria Simpson, Greenwood Village, CO (US)

(21) Appl. No.: 14/339,299

(22) Filed: Jul. 23, 2014

Related U.S. Application Data
(60) Provisional application No. 61/857,535, filed on Jul. 23, 2013.

(51) Int. Cl. G06Q 20/04; G06K 9/00

(52) U.S. Cl. CPC G06Q 20/0425; G06K 9/00442
USPC 705/39

(57) ABSTRACT

Systems and methods are provided for digital check conversion. In one embodiment, a method is provided. The method may include accessing, by a computer, respective check information associated with one or more checks. The method may also include generating, by the computer based at least in part on the respective check information, machine-readable code. Furthermore, the method may include presenting, by the computer, the machine-readable code to a payment device for payment of one or more items.

### CROSS-REFERENCE TO RELATED APPLICATION

This application claims the benefit of U.S. Provisional Application No. 61/857,535, filed Jul. 23, 2013, entitled “Systems and Methods for Digital Check Conversion,” the contents of which are hereby incorporated by reference.

### FIELD OF THE DISCLOSURE

The disclosure generally relates to processing checks, and more particularly relates to systems and method for digital check conversion.

### BACKGROUND

With the advent of the digital age, online banking and financial transactions have gained prevalence. However, physical checks may still be widely circulated. To this end, financial information included with the physical checks may be converted into digital form to improve ease of processing.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a system for digital check conversion in accordance with one or more example embodiments.

FIG. 2 illustrates a block diagram of check information in accordance with one or more example embodiments.

FIG. 3 illustrates a block diagram of a data flow for digital check conversion in accordance with one or more example embodiments.

FIG. 4 illustrates a flow diagram of a method for digital check conversion in accordance with one or more example embodiments.

FIG. 5 illustrates a flow diagram of a method for digital check conversion in accordance with one or more example embodiments.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like, but not necessarily the same or identical, elements throughout. Hence, if a feature is used across several drawings, the number used to identify the feature in the drawing where the feature first appeared will be used in later drawings.

### DETAILED DESCRIPTION

### Overview

Described herein are systems and methods for digital check conversion. Broadly, the systems and methods described herein may facilitate the conversion of a check (e.g., a physical check) into digital form for digital and/or online processing by a financial system. Thus, one or more user devices may be in communication with a service provider server. As such, the user device may be configured to access check information associated with a check and/or a physical check. A check application (e.g., stored on the user device, one or more service provider servers, and/or a combination thereof) may be configured to analyze the check information and generate a virtual check based on the check information. Based on the virtual check, the check application may be configured to convert the virtual check to machine-readable code.

Thus, according to one or more embodiments of the disclosure, a method is provided for digital check conversion. The method may include accessing, by a computer including one or more processors, respective check information associated with one or more checks. The method may also include generating, by the computer, machine-readable code that includes the respective check information. Furthermore, the method may include presenting, by the computer, the machine-readable code to a payment device for payment of one or more items.

According to one or more other embodiments of the disclosure, a non-transitory computer readable medium is provided. The computer readable medium may include computer-executable instructions that may be executed by at least one processor. When executed by the at least one processor, the computer-executable instruction may cause the at least one processor to access respective check information associated with one or more checks. The computer-executable instructions may also cause the at least one processor to generate, based at least in part on the respective check information, machine-readable code, wherein the machine-readable code comprises the respective check information. Furthermore, the computer-executable instructions may also cause the at least one processor to present the machine-readable code to a payment device for payment of one or more items.

According to one or more other embodiments of the disclosure, a device is provided. The device may include at least one memory for storing data and computer-executable instructions. The device system may also include at least one processor to access the at least one memory and to execute the computer-executable instructions. The at least one processor may be configured to execute the instructions to access respective check information associated with one or more checks. The at least one processor may also be configured to execute the instructions to generate, based at least in part on the respective check information, machine-readable code, and the machine-readable code may include the respective check information. The at least one processor may further be configured to present the machine-readable code to a payment device for payment of one or more items.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Embodiments

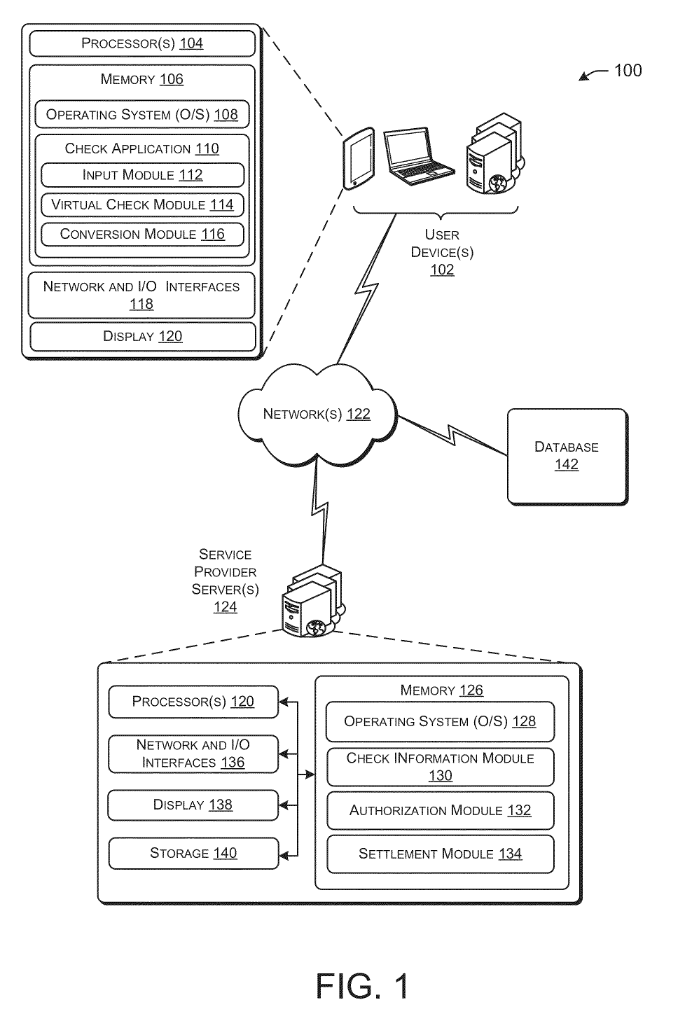

With reference now to FIG. 1, a system 100 for generating digital check conversion is shown according to one or more embodiments of the disclosure. The system 100 may include one or more user device(s) 102. In general, the user device 102 may refer to any type of electronic device, and, more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The user device(s) 102 may include one or more computer processors 104, and a memory 106 storing an operating system 108 and a check application 110. The check application 110 may include an input module 112, a virtual check module 114, and a conversion module 116. In addition, the user device(s) 102 may include a, network and I/O interfaces 118, and a display 120. In certain embodiments, the user device(s) 102 may include one or more sensors capable of gathering information associated with a present environment of the user device(s) 102, or similar hardware devices, such as a camera, microphone, antenna, a gesture capture or detection device, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 102 may also include a chipset (not shown) for controlling communications between the one or more processors 104 and one or more of the other components of the user device 102. In certain embodiments, the one or more processors 104 may also include one or more application-specific integrated circuits (ASICs) or application-specific standard products (ASSPs) for handling specific data processing functions or tasks.

The memory 106 may include one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the user device 102. The memory 106 may also store content that may be displayed by the user device 102 or transferred to other devices (e.g., headphones) to be displayed or played by the other devices. The memory 106 may also store content received from the other devices. The content from the other devices may be displayed, played, or used by the user device 102 to perform any necessary tasks or operations that may be implemented by the computer processor or other components in the user device 102.

The network and I/O interfaces 112 may also include one or more communication interfaces or network interface devices to provide for the transfer of data between the user device 102 and another device (e.g., network server) via a network (not shown). The communication interfaces may include, but are not limited to: personal area networks (PANs), wired local area networks (LANs), wireless local area networks (WLANs), wireless wide area networks (WWANs), and so forth. The user device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the user device 102 and another device, such as an access point, a host computer, a server, a router, a reader device, and the like. The network may include, but is not limited to, the Internet, a private network, a virtual private network, a wireless wide area network, a local area network, a metropolitan area network, a telephone network, and so forth.

The display 120 may include, but is not limited to, a liquid crystal display, a light-emitted diode display, or an E-Ink™ display as made by E Ink Corp. of Cambridge, Mass. The display 120 may be used to show content to a user in the form of text, images, or video. In certain instances, the display 120 may also operate as a touch screen display that may enable the user to initiate commands or operations by touching the screen using certain finger or hand gestures.

The user device(s) 102 may also be in communication with one or more service provider server(s) 124, such as via a network 122. The service provider server(s) 124 may include one or more processor(s) 126 and at least one memory 128, which may store an operating system 130, a data extraction module 132, an authorization module 134, and a settlement module 136. Furthermore, the service provider server(s) 124 may include network and I/O interfaces 138, a display 140, and storage 142. In some implementations, the service provider server(s) 114 may be associated with one or more financial institutions and/or financial systems.

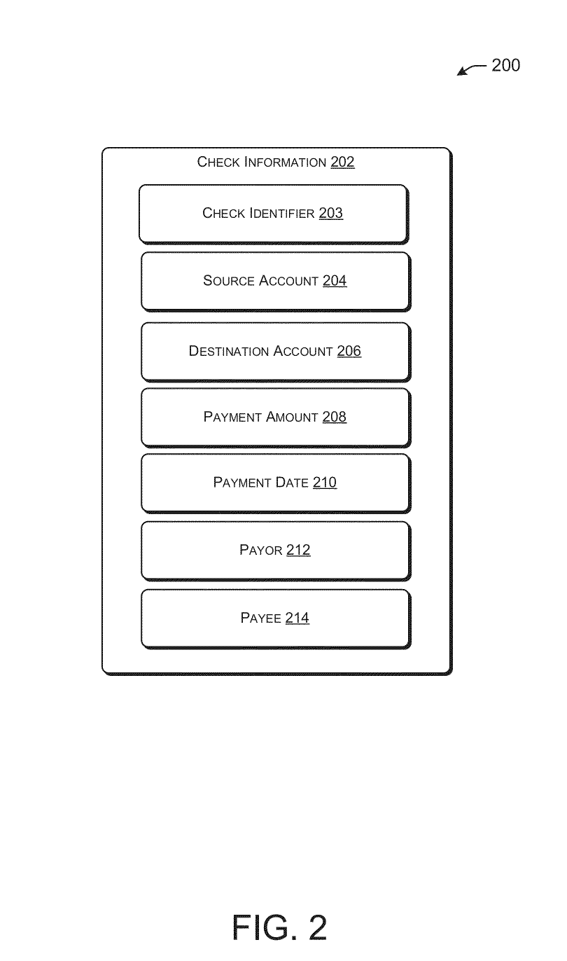

According to one or more embodiments, the check application 110 may be configured to access check information associated with on or more checks and generate/convert the check information into digital form (e.g., machine-readable code). The check information may include various types of information that may be associated with a physical check. For example, FIG. 2 illustrates a block diagram 200 of check information 202 according to one or more example embodiments. As shown in FIG. 2, check information 202 for a check may include information associated with a check identifier 203, source account 204, a destination account 206, a payment amount 208, a payment date 210, a payor 212, and a payee 214. The check identifier 203 may be a check number and/or any other type of indicator configured to identify the check. The source account 204 may include an identifier (e.g., an account number and/or any other type of identifier) associated with a financial account from which to withdraw funds. The destination account 206 may include an identifier (e.g., an account number and/or any other type of identifier) associated with a financial account in which to deposit funds, such as those withdrawn from the source account 204. The payment amount 208 may indicate the quantity or amount of funds to be transferred from the source account 204 to the destination account 206. The payment date 210 may be associated with a date in which the check was created and/or generated. The payor 212 may indicate an entity associated with the source account 204 while the payee 214 may indicate an entity associated with the destination account 206. It will be appreciated that the components of the check information 202 illustrated in FIG. 2 are not limiting or exhaustive, and that that the check information 202 may include other data associated with checks.

According to one or more embodiments, in order to access the check information 202, the check application 110 may include an input module 112 configured to receive check information 202 associated with a check. Various methods for receiving, retrieving, and/or otherwise accessing the check information 202 are contemplated. In some implementations, a user of the user device 102 may manually input check information 202 (e.g., and/or one or more components of the check information 202). For instance, the check application 110 may provide a user interface that prompts the user to enter one or more of the check information 202 into one or more fields.

Alternatively, the user device 102 may include a sensor, such as a camera, video recorder, and/or other type of image capturing device, to capture and/or other generate an image of the check. In certain embodiments, the image may be an image cash letter and/or any other type of digital check associated with the check. To this end, the check application 110 may be configured to determine the check information 202 from the image, such as via optical character recognition (OCR) or by any other means. For instance, using an OCR algorithm, the check application 110 may determine a check identifier 203, source account 204, a payment amount 208, a payment date 210, a payor 121, and/or a payee 214 from the image.

In certain implementations, performing OCR may include performing magnetic ink character recognition (MICR) on the image of the check. For example, the check application 110 may identify a portion of the image of the check corresponding to MICR numbers and/or characters. In some cases, the image may be a real-time image provided to a display 120 via a camera included on the user device 102. Upon identifying one or more MICR numbers in the identified portion of the image, the check application 110 may continuously search adjacent areas (e.g., to the “left” and to the “right” of the identified portion) for additional MICR numbers and/or characters until no more MICR numbers and/or characters can be found, or until a maximum number of MICR numbers and/or characters are identified (e.g., a maximum of 25 MICR numbers and/or characters). The check application 110 may be configured to display and/or otherwise present the identified MICR numbers and/or characters to the user. In certain implementations, the check application 110 may also be configured to provide a visual indication of the MICR numbers and/or characters on the image of the check (e.g., an outline, such as a box, surrounding the MICR numbers and/or characters on a real-time image of the check).

According to some implementations, the check application 110 may be configured to generate an image of the check based at least in part on user input. For instance, in order to capture or generate an acceptable image of the check, the check application 102 may be configured to identify one or more corners of the check in the image (e.g., identify the boundaries of the check based on the image of the check). To this end, the check application 102 may request user input to facilitate identification of the one or more corners. For instance, the check application 110 may be configured to display an image of the check (e.g., a real-time image provided by a camera and/or a previously stored image of the check), such as via the display 120. Upon displaying the image of the check, the check application 110 may prompt the user for interactions and/or inputs to facilitate identification of the one or more corners of the check.

For example, the display 120 may be a touch-sensitive display. The check application 110 may request that the user touch an area on the display 120 corresponding to a center location of the check with respect to the image being produced by the display 120. Based on the area of the display 120 indicated by the user, the check application may be configured to identify the one or more corners of the check (e.g., the check application 110 may identify the one or more corners as a function of relative distances from the location indicated by the user). As another example, the check application 110 may request that the user adjust and/or resize the image of the check such that only the check is visible on the display 110 (e.g., such that any background images are not visible) and such that the entirety of the check is visible on the display 120. It will be appreciated that the user may perform such adjustments to the image via one or more touch screen gestures on the display 120 (e.g., pinching or pulling to zoom in and/or zoom out, etc.) or by any other input means. Upon receiving confirmation from the user that the image has been properly adjusted, the check application 110 may be configured to identify the one or more corners of the check. For example, the check application 110 may determine that one or more corners on the boundary of the display area associated with the display 120 correspond to the one or more corners of the check.

According to certain implementations, the check application 102 may determine check information 202 associated with the check based on one or more audio signals. For example, a user device 102 may include a microphone and/or any other type of audio capturing device. The check application 110 may be configured to activate the microphone in response to one or more user inputs, such as via a user interface. While the microphone is activated, the microphone may be configured to receive audio signals, such as voice commands or voice signals from the user. For instance, the user may be prompted to speak words that indicate the check information 202 associated with the check. To this end, the check application 110 may be configured to perform speech recognition on the received voice signals from the user in order to determine and/or identify one or more components of the check information 202.

It will be appreciated that various other means by which the check information 202 is received, accessed, and/or otherwise provided to the check application 110 are also contemplated. For instance, the check information 202 may be provided and/or transmitted by a third-party device, such as another user device.

According to certain embodiments, the check application 110 may include an input module 110 to receive and/or otherwise access respective check information 202 associated with one or more checks, such as by the various means described above. In response to receiving and/or otherwise accessing the check information 202, the input module 112 may be configured to provide the respective check information 202 to a virtual check module 114. To this end, the virtual check module 114 may be configured to generate, based at least in part on the respective check information 202, one or more virtual checks, which may individually include the respective check information 202 associated with the one or more checks. In certain implementations, the virtual checks may include one or more image cash letters associated with the one or more checks. Furthermore, the virtual check module 114 may be configured to provide the virtual checks and/or image cash letters to a conversion module 116. To this end, the conversion module 116 may be configured to generate machine-readable code based at least in part on information associated with virtual checks and/or the image cash letters. In other implementations, the input module 112 may be configured to directly provide the respective check information 202 to the conversion module 116. In response, the conversion module 116 may generate machine-readable code representing the respective check information 202.

For instance, in certain implementations, machine-readable code associated with a particular check may be a quick response (QR) code. As such, the check application 110 may be configured to present the QR code associated with the check, such as to a payment device, as a method of payment. For instance, the check application 110 may be configured to display the QR code, and a payment device (e.g., a scanner or other type of image capturing device) may be configured to scan the QR code. Upon scanning the QR code, the scanner may extract the check information 202 associated with the particular check represented by the QR code. The check information 202 may then be transmitted to one or more service provider servers 124 for settlement. In certain embodiments, a QR code may be configured to store check information 202 associated with a single check. In other embodiments, the QR code may be configured to store respective check information 202 associated with multiple checks.

In certain implementations, the one or more service provider server(s) 124 may include a check information module 132 configured to receive, access, extract, and/or otherwise determine the check information 202. Once the check information module 132 has determined the check information 202, the authorization module 134 may analyze the check information 202 to determine whether payment according to the check information 202 is authorized. If the payment is not authorized, the authorization module 134 may deny processing of the payment. If the payment is authorized, the authorization module 134 may provide the check information 202 to the settlement module 136 for settlement of the associated payment.

In other embodiments, upon generation of the virtual checks and/or image cash letters (e.g., via the virtual check module 114), the check application 110 may not convert the virtual checks and/or image cash letters to machine-readable code. Instead, the check application 110 may be configured to transmit the virtual checks (e.g., via Bluetooth, Near-Field Communication, and/or any other type of wireless and/or wired communication protocol) directly to the service provider server(s) 124. In yet other embodiments, the check application 110 may also be configured to transmit the virtual checks and/or image cash letters to a second user device which may include a second check application. For example, a first user of the user device 102 may wish to pay, by check, a second user of the second user device. To this end, the check application 110 of the user device 102 may transmit a virtual check to the second check application included in the second user device. The second check application may be configured to transmit the virtual check to a bank of the second user, which may process the virtual check for payment

In certain implementations, upon generation of the virtual checks and/or image cash letters, the check application 110 may provide a notification to a financial institution computer (not pictured) in communication with the user device. The notification may indicate to the financial institution computer that a virtual check for payment amount 208 has been created. Additionally, the financial institution computer may be configured to generate a copy of the virtual check until the actual payment amount 208 is received.

While FIG. 1 illustrates the check application 110 as stored in the user device(s) 102, it should be appreciated that the functionality provided by the check application 110 and/or any of its components may be distributed among any combination of devices/components included in the system 100. For example, in some implementations, the functionality provided by the virtual check module 114 and/or the conversion module 116 may be performed by the one or more service provider server(s) 124. As such, the user device 102 may be configured to provide the check information 202 to the one or more service provider server(s) 124, and the one or more service provider server(s) 124 may perform the conversion of the check information 202 into machine-readable code.

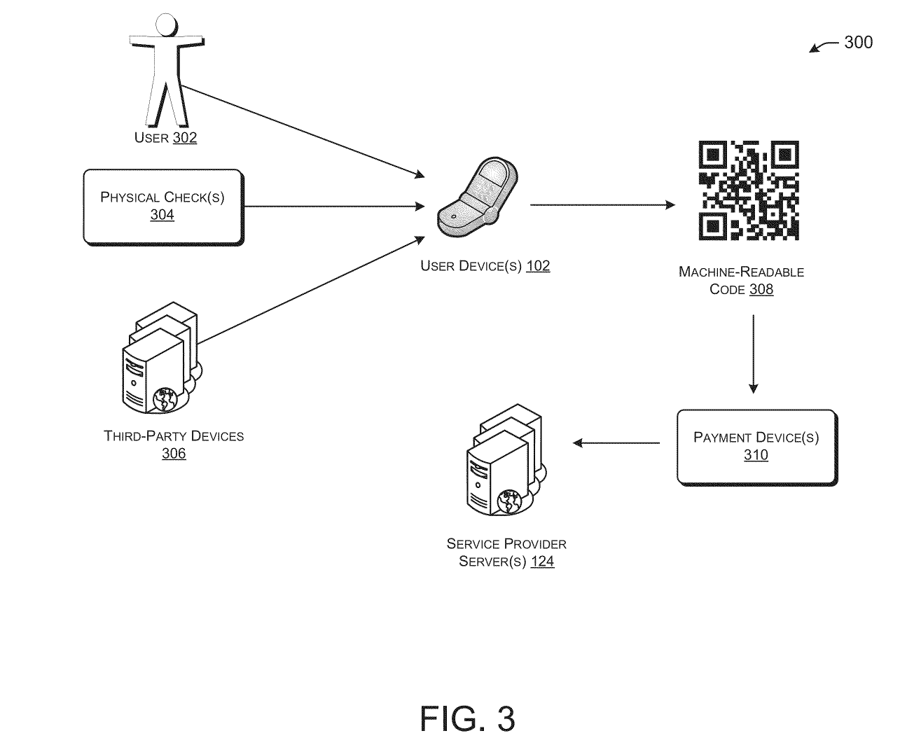

Turning now to FIG. 3, a block diagram of a data flow 300 for digital check conversion is illustrated according to one or more example embodiments. The data flow 300 may include providing check information 202 associated with a check (e.g., physical check 304 and/or a digital check) to a user device(s) 102. For instance, the check information may be provided by a user 302 (e.g., the user may manually input check information 202 to the user device 102). As another example, the user device may be configured to determine check information 202 from a physical check 304. For instance, the user device(s) 102 may capture and/or otherwise generate an image of the physical check 304, perform OCR with respect to the image, and determine check information 202 therefrom. In yet other examples, a third-party device 306 may be configured to transmit check information 202 to the user device(s) 102.

According to one or more embodiments, the user device(s) 102 may be configured to generate, based at least in part on the check information 202, machine-readable code 308 (e.g., a QR code). For instance, an input module 112 of the check application 110 included in the user device may be configured to receive the check information 202 and provide the check information 202 to a conversion module 116. The conversion module 116 may be configured to generate machine-readable code 308 based at least in part on the check information. Furthermore, the machine-readable code 308 may include the check information 202. In some implementations, the machine-readable code 310 may include a Quick Response (QR) code, but other types of machine-readable code are also contemplated, such as barcodes and/or the like.

In certain implementations, the machine-readable code 308 may be presented to one or more payment device(s) 310 for payment of an item. For instance, the user device 102 may be configured to display the machine-readable code 308, such as on a display 120. To this end, the payment device 310 may include a barcode scanner and/or any other type of image capturing device capable of reading an image of the machine-readable code 308. The one or more payment devices 310 may be configured to extract the check information 202 from the machine-readable code 308 and provide the check information 202 to one or more service provider servers 124 for settlement of the check associated with the check information 202.

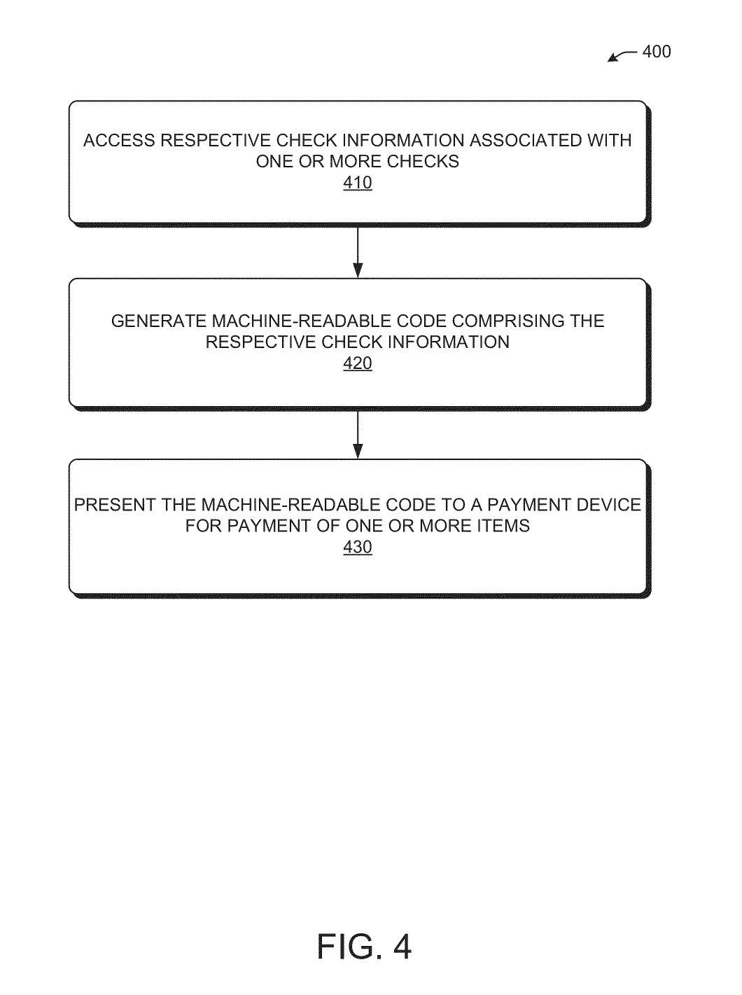

Turning now to FIG. 4, a flow diagram of a method 400 for digital check conversion is illustrated according to one or more example embodiments. The method 400 may include block 410, in which a computer, such as a user device 102, service provider server 124, and/or a combination thereof may access or otherwise receive respective check information 202 associated with one or more checks (e.g., one or more physical checks 304 illustrated in FIG. 3). In block 420, the computer may generate machine-readable code (e.g., machine readable code 310 illustrated in FIG. 3), which may include the respective check information 202. In certain implementations, the machine-readable code may be a QR code from which the check information 202 may be extracted. In block 430, the computer may present the machine readable code to a payment device for payment of one or more items. To this end, payment of the one or more items may be performed using the check information 202 stored in the machine-readable code.

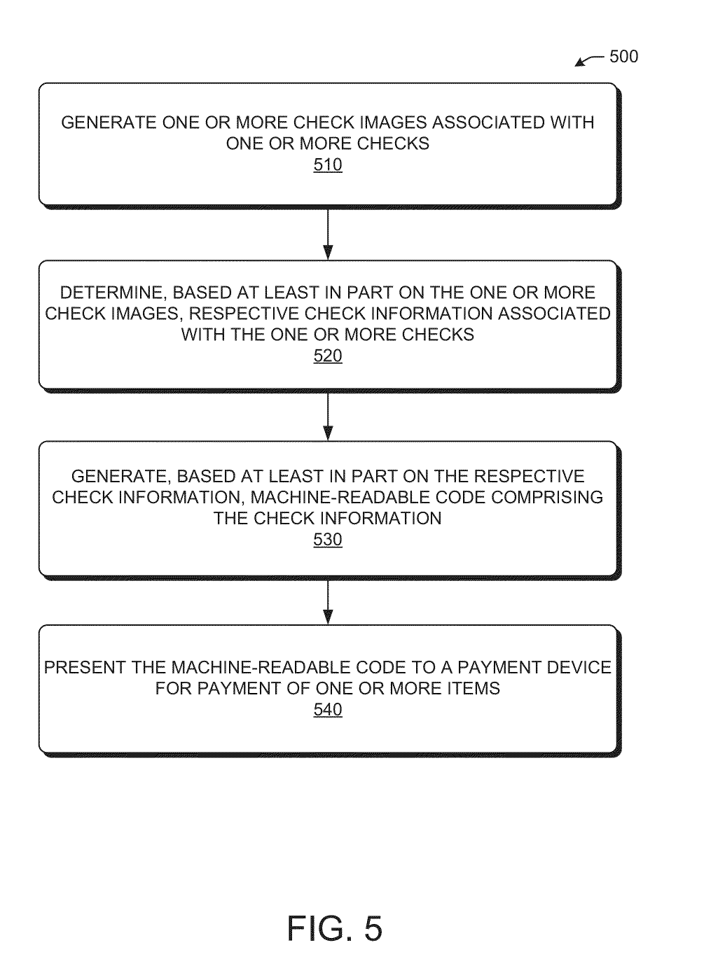

Turning now to FIG. 5, a flow diagram of a method 500 for digital check conversion is illustrated according to one or more example embodiments. The method 500 may include block 510, in which a computer, such as a user device 102, service provider server 124, and/or a combination thereof may generate, access, and/or otherwise receive one or more check images associated with one or more checks (e.g., one or more physical checks 304 illustrated in FIG. 3). In block 520, a check application (e.g., check application 110 illustrated in FIG. 1) included in the computer may determine, based at least in part on the one or more check images, respective check information (e.g., check information 202 illustrated in FIG. 2) associated with the one or more checks. For instance, the check application 110 may perform and/or otherwise apply OCR algorithms on the one or more check images. As a result of applying the OCR, the check application 110 may be able to identify check information associated with the one or more checks.

In block 530, the computer and/or check application 110 may generate, based at least in part on the respective check information 202, machine-readable code (e.g., machine readable code 310 illustrated in FIG. 3), which may include the check information. In block 540, the computer and/or the check application 110 may be configured to present the machine-readable code to a payment device for payment of one or more items. To this end, payment of the one or more items may be performed using the check information 202 stored in the machine-readable code.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

That which is claimed in certain embodiments is:

1. A method, comprising:
accessing, by a computer comprising one or more processors, respective check information associated with one or more checks;
generating, by the computer based at least in part on the respective check information, machine-readable code, wherein the machine-readable code comprises the respective check information; and
presenting, by the computer, the machine-readable code to a payment device for payment of one or more items.

2. The method of claim 1, wherein accessing respective check information comprises receiving the check information via one or more inputs from a user of the computer.

3. The method of claim 1, wherein accessing respective check information comprises:
generating, by the computer, one or more electronic check images associated with the one or more checks;
determining, by the computer, optical character recognition (OCR) data associated with the one or more electronic check images; and
determining, by the computer based at least in part on the OCR data, the respective check information.

4. The method of claim 3, wherein the one or more electronic check images comprises one or more image cash letters.

5. The method of claim 3, wherein generating the one or more electronic check images comprises:
receiving, by the computer, one or more image-focusing inputs from a user associated with a first check;
identifying, based at least in part on the image-focusing inputs, one or more check corners associated with the first check; and
generating, based at least part on the one or more identified check corners, a first electronic check image associated with the first check.

6. The method of claim 1, wherein the machine-readable code comprises at least one of a Quick Response (QR) code or a barcode.

7. The method of claim 1, wherein the machine-readable code comprises information associated with at least one of a check identifier, a source account, a destination account, a payor, a payee, an amount, a check number, or a date.

8. A device, comprising:
a display
at least one processor; and
at least one memory storing computer-executable instructions, that when executed by the at least one processors, cause the at least one processor to:
access respective check information associated with one or more checks;
generate, based at least in part on the respective check information, machine-readable code, wherein the machine-readable code comprises the respective check information; and
present, via the display, the machine-readable code to a payment device for payment of one or more items.

9. The device of claim 8, wherein the computer-executable instructions to access the respective check information further comprises computer-executable instructions to:
receive the check information via one or more inputs from a user of the computer.

10. The device of claim 8, wherein the computer-executable instructions to access the respective check information further comprises computer-executable instructions to:
generate one or more electronic check images associated with the one or more checks;
determine optical character recognition (OCR) data associated with the one or more electronic check images; and
determine, based at least in part on the OCR data, the respective check information.

11. The device of claim 10, wherein the one or more electronic check images comprises one or more image cash letters.

12. The device of claim 10, wherein the computer-executable instructions to generate the one or more electronic check images further comprises computer-executable instructions to:
receive one or more image-focusing inputs from a user associated with a first check;
identify, based at least in part on the image-focusing inputs, one or more check corners associated with the first check; and
generate, based at least part on the one or more identified check corners, a first electronic check image associated with the first check.

13. The device of claim 8, wherein the machine-readable code comprises at least one of a Quick Response (QR) code or a barcode.

14. The device of claim 8, wherein the machine-readable code comprises information associated with at least one of a check identifier, a source account, a destination account, a payor, a payee, an amount, a check number, or a date.

15. A non-transitory computer-readable medium comprising computer-executable instructions, that when executed by at least one processor, causes the at least one processor to:
access respective check information associated with one or more checks;
generate, based at least in part on the respective check information, machine-readable code, wherein the machine-readable code comprises the respective check information; and
present the machine-readable code to a payment device for payment of one or more items.

16. The computer-readable medium of claim 15, wherein the computer-executable instructions to access the respective check information further comprises computer-executable instructions to:
receive the check information via one or more inputs from a user of the computer.

17. The computer-readable medium of claim 15, wherein the computer-executable instructions to generate the one or more electronic check images further comprises computer-executable instructions to:
receive one or more image-focusing inputs from a user associated with a first check;
identify, based at least in part on the image-focusing inputs, one or more check corners associated with the first check; and
generate, based at least part on the one or more identified check corners, a first electronic check image associated with the first check.

18. The computer-readable medium of claim 17, wherein the one or more electronic check images comprises one or more image cash letters.

19. The computer-readable medium of claim 17, wherein the computer-executable instructions to generate the one or more electronic check images further comprises computer-executable instructions to:
receive one or more image-focusing inputs from a user associated with a first check;
identify, based at least in part on the image-focusing inputs, one or more check corners associated with the first check; and
generate, based at least part on the one or more identified check corners, a first electronic check image associated with the first check

20. The computer-readable medium of claim 15, wherein the machine-readable code is a quick response (QR) code.
